(19) United States
(12) Patent Application Publication
(10) Pub. No.: US 2004/0183292 A1
(43) Pub. Date: Sep. 23, 2004

(54) Inflation device for a vehicle occupant restraint system

(75) Inventor: Rolf Ruckdeschel, Schwangau (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Airbag Systems GmbH

(21) Appl. No.: 10/800,547

(22) Filed: Mar. 15, 2004

(30) Foreign Application Priority Data
Mar. 17, 2003 (DE) 203 04 249.2

(51) Int. Cl. B60R 21/28

(52) U.S. Cl. 280/741

(57) ABSTRACT

An inflation device (10) adapted for use in a vehicle occupant restraint system comprises a housing (12), an igniter (14) received in the housing, and a first cord-type gas generator (22) connected to the housing (12), the cord-type gas generator (22) including a cord-shaped propellant strand (24). The igniter housing (12) has at least one relief opening (20a, 20b) which is associated to a surrounding region outside the cord-type gas generator (22) and the housing (12).

### FIELD OF THE INVENTION

The invention relates to an inflation device for a vehicle occupant restraint system, comprising a housing, an igniter received in the housing, and a first cord-type gas generator connected to the housing and having a cord-shaped propellant strand.

### BACKGROUND OF THE INVENTION

Inflation devices including cord-type gas generators are used whenever a particularly rapid generation of gas is to be brought about. DE 41 34 995 C1 shows a side impact protection system for occupants of a motor vehicle, in which a propellant strand is used in a gas generation cord; through this propellant strand the gas is generated directly at the place where required, thus avoiding time-consuming flow processes. Such systems have the short reaction times that are required in a side impact. Inflation devices with cord-shaped propellant strands can circumscribe areas of any shape, thus allowing a very good adaptation of side impact protection devices to the spatial conditions in a motor vehicle.

The igniters used for such inflation devices are of special design and, therefore, very expensive. Igniters in series production of conventional pyrotechnical inflation devices, such as front airbags for drivers or passengers, have a very high output and are not suitable for being used with cord-type gas generators for this reason. If such conventional igniters were used for igniting a cord-shaped propellant strand, the latter would be damaged or deformed such that its operational reliability could not be guaranteed any more.

In DE 101 36 458 A1 there is shown a combination of a cord-type gas generator and a pyrotechnical gas generator, with the cord-type gas generator being connected to the pyrotechnical gas generator through a connecting channel. As the combustion products released by the cord-type gas generator are predominantly gaseous, a safe activation of the pyrotechnical gas generator is not always ensured.

### SUMMARY OF THE INVENTION

In comparison with this, the invention provides an inflation device of the type initially mentioned, which is of simple construction and can be produced at favorable cost and in which the housing has at least one relief opening which is associated to a surrounding region outside the first cord-type gas generator. Thus, the energy of the combustion products released by the igniter can only partially affect the cord-shaped, gas-generating propellant strand, while the further proportions of the released combustion products can leave the igniter housing through the relief opening(s). With this, on the one hand, a reliable ignition of the propellant strand is also guaranteed on using a conventional series igniter with high power output, and on the other hand it is ensured that nor the housing neither the cord-shaped propellant strand are destroyed by excessively high mechanical forces or damaged so severely that the proper functioning of the entire inflation device is impaired. It is possible by dimensioning the flow cross-section of the relief openings to have a very precise control of the amount of energy acting on the propellant strand. Thus, the standard components used hitherto can be modified in an easy manner by incorporating appropriate bores in the igniter connection housing. This allows to use low-cost components for the production of the inflation device according to the invention.

“Cord-shaped” propellant strands in the sense of the invention are such with a ratio of length to diameter (aspect ratio) of more than 50, preferably more than 100.

A particularly preferred embodiment is one in which the housing encircles an igniter chamber and the igniter chamber is in flow connection with a surrounding region outside the housing through at least one of the relief openings after activation of the igniter. This means that combustion products generated by the igniter will flow from the igniter chamber into the surrounding region without having the chance of developing a further ignition effect. Preferably, at least one filter is associated to the further openings.

In a further embodiment, the inflation device has an additional pyrotechnical gas generator including propellant elements, which gas generator is in flow connection through one of the relief openings with the igniter, so that the propellant elements are ignited by the combustion products released by the igniter, these propellant elements preferably having a much longer combustion time than the cord-shaped propellant strand. In this way the propellant elements of the pyrotechnical gas generator can be ignited without an additional igniter. With this, additional gas for operating the inflation device will be furnished by the further propellant elements. As the propellant elements deliver gas for a much longer period of time than the propellant strand which bums down comparably quick, the useful life of the gas bags in the solution illustrated here can be remarkably enhanced as compared with embodiments with pure cord-type gas generators.

It is preferred that the propellant elements are propellant tablets arranged in loose fill. This embodiment ensures a reliable combustion of the propellant elements.

It is particularly preferred that the inflation device has at least one further cord-type gas generator connected to the igniter housing. In this way it is possible to inflate various protection devices at individual places in the vehicle. Through the size of the openings in the housing which are associated to the respective cord-type gas generators it is possible to precisely define the amount of energy delivered to the individual propellant strands.

### BRIEF DESCRIPTION OF THE DRAWINGS

Further advantages of the invention will be apparent from the following description of preferred embodiments and the drawings in which:

FIG. 1 is a schematic cross-sectional view of a first embodiment of an inflation device according to the invention,

FIG. 2 is a section through a detail of a second embodiment of the inflation device according to the invention, and

FIG. 3 is a schematic cross-sectional view of a third embodiment of an inflation device according to the invention.

### DETAILED DESCRIPTION OF THE INVENTION

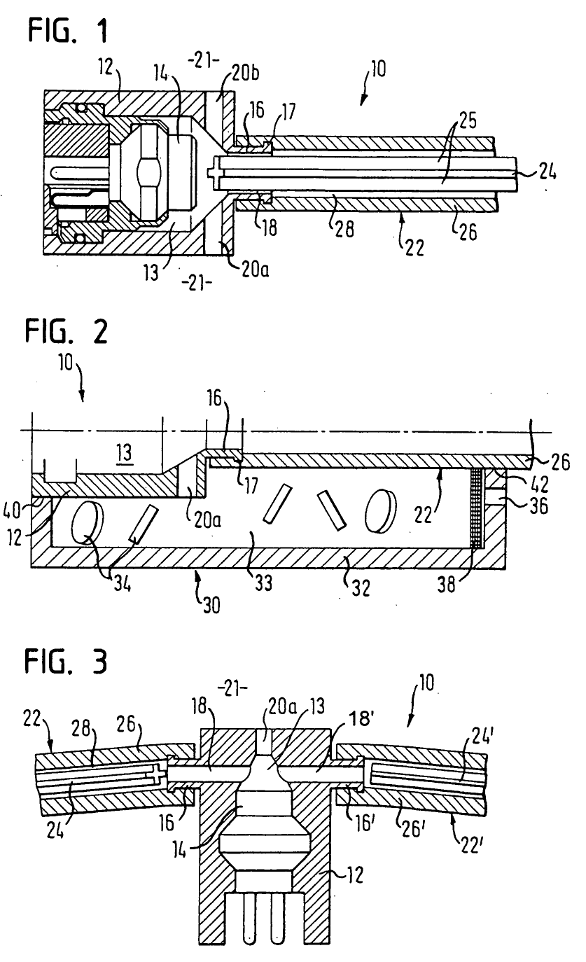

The preferred embodiment of an inflation device 10 illustrated in FIG. 1 shows a housing 12 with an igniter 14 received in an igniter chamber 13. Opposed to the igniter 14, the housing 12 has a tube-shaped extension 16 with a circular, first opening 18 arranged centrally therein. In addition, the housing 12 has relief openings 20a and 20b the middle axes of which are perpendicular to the middle axis of the first opening 18. In the state of operation, upon activation of the igniter 14, the relief openings 20a and 20b make a flow connection between the igniter chamber 13 and a free surrounding region 21. In the state of rest, the relief openings 20a, 20b are sealed off against the surrounding region 21 preferably by an insulation of an aluminum foil.

The inflation device 10 further has a cord-type gas generator 22 with a cord-shaped, gas-generating propellant strand 24 and a tubular housing 26 which surrounds the propellant strand and preferably is made of a pressure-proof material. The propellant strand 24 has a cross-shaped cross-section, whereby passage channels 25 are formed in the longitudinal direction of the cord-type gas generator. The outer dimensions of the propellant strand 24 are slightly smaller than the inner dimensions of the tubular housing 26, whereby a gap 28 is produced between the propellant strand and the tubular housing. With this, the propellant strand 24 can easily be pushed into the tubular housing 26 and is nevertheless reliably fixed therein. The cord-type gas generator 22 with an essential part of its longitudinal dimensions extends into an inflatable safety arrangement (not shown here), as it is commonly known.

For connecting the cord-type gas generator 22 to the housing 12, at the end facing the igniter 14, the propellant strand 24 projects beyond the tubular housing 26 into the first opening 18 and the igniter chamber 13. In this arrangement, the tubular housing 26 is slipped over the extension 16 of the igniter housing 12, the extension 16 being located in the gap 28 between the propellant strand 24 and the tubular housing 26. Arranged on the free end of the extension 16 is an outer bead 17 which ensures that the tubular housing 26 of the cord-type gas generator 22 is reliably, tightly and firmly fixed to the igniter housing 12. The tubular housing may also be slipped into the tube-shaped extension and in addition be fixed there in a suitable manner, for instance by welding, gluing or soldering.

The mode of operation of this embodiment will be illustrated in the following:

As soon as a sensor arranged in the vehicle detects a vehicle collision, the igniter 14 is activated through an electrical signal. The igniter 14 produces a gas pressure wave which ignites the propellant strand 24. The passage channels formed between the cross legs of the propellant strand 24 guide the pressure wave, generated by the igniter 14, along the entire cord-type gas generator at supersonic speed. Due to this, the propellant strand 24 is ignited very rapidly everywhere across its surface area and bums down within few milliseconds. The gas released from the cord-shaped propellant strand 24 then inflates the safety arrangement, for example a side gas bag, associated to the cord-type gas generator 22.

The energy released by the igniter 14 and not needed for igniting is discharged from the igniter housing 12 to the free surrounding region 21 through the relief openings 20a, 20b, for relieving the cord-shaped propellant strand 24. The diameter of the further openings 20a, 20b are dimensioned here such that a sufficient power is available for igniting the cord-shaped propellant strand 24, the propellant strand 24, however, not being deformed or damaged or even torn out of its anchoring on the extension 16, which would mean that it looses its operability.

In FIG. 2 there is illustrated a second embodiment of the invention in a detail view. The igniter (not shown here), the housing 12 and the cord-type gas generator 22 are realized just like in the first embodiment, with elements of identical function having the same reference numeral.

Here, the inflation device 10 further has a pyrotechnical gas generator 30 with a gas generator housing 32 encircling a combustion chamber 33 with propellant tablets 34 arranged therein. The pyrotechnical gas generator 30 is in flow connection with the igniter chamber 13 at least through the relief opening 20a (see FIG. 1). Axially or radially directed outflow openings 36 are provided at the end of the gas generator housing 32 facing away from the igniter housing 12. A filter 38 is arranged in the combustion chamber 33 in the region of the outflow openings 36. It is particularly preferred that the housing 12 and an end section of the cord-type gas generator 22 adjoining the housing 12 are encircled circumferentially by the housing 32 of the pyrotechnical gas generator 30. In this embodiment, the combustion chamber 33 defines the surrounding region 21.

Moreover, the gas generator housing 32 is connected to the housing 12 in a gas-tight manner at a first connection site and to the tubular housing 26 of the cord-type gas generator 22 at a second connection site.

The second embodiment of the inflation device functions as follows:

The igniter 14 is activated in the case of a vehicle collision in the same manner as in the first embodiment. Here too, part of the combustion products released from the igniter, or the gas pressure wave generated by the igniter, suddenly ignites the propellant strand 24, while a further part of the combustion products enters the propellant chamber 33 of the pyrotechnical gas generator 30 through the opening 20a and ignites the propellant tablets 34. The gas developing from the ignition of the propellant tablets 34 is then filtered and cooled in the filter 38 and leaves the pyrotechnical gas generator 30 through the outflow openings 36. Through further means (not illustrated) the gas may then be delivered to a vehicle occupant protection device, for instance an airbag. As the combustion time of the propellant tablets 34 is significantly longer than that of the cord-shaped propellant strand 24, it is possible to extend the useful life of the inflated airbag. With this, the protective effect of the airbag is remarkably improved, especially in accident situations such as a roll-over in which the occupant needs to be protected by the airbag several times within a very short period.

FIG. 3 shows in a third embodiment the inflation device 10 with the igniter 14 in the housing 12. Here, the housing 12 has two radially protruding extensions 16 and 16′ with one cord-type gas generator 22 and 22′ each connected thereto via openings 18 and 18′, respectively. The cord-type gas generators 22, 22′ can be arranged in various regions—which may be arranged even quite remote from each other—of the vehicle interior. Just like in the first embodiment, they are made up of a cord-shaped propellant strand 24, 24′ and a tubular housing 26, 26′. Here, the cord-type gas generator 22 has its right end connected to the extension 16 of the igniter housing 12, the cord-type gas generator 22′ has its left end connected to the extension 16′ of the housing.

The mode of operation of the third embodiment of the inflation device will be explained in the following:

In case the igniter 14 is activated, the released combustion products or the gas pressure wave ignite the two propellant strands 24 and 24′. Part of the combustion products comes out through the opening 20a into the surrounding region 21. The ratio of the ignition power, delivered to the cord-type gas generators 22, 22′, to the relief discharged through the opening 20a into the surrounding region 21 can be set by the size of the openings 18, 18′ and 20a.

It will be appreciated that apart from the two illustrated cord-type gas generators 22, 22′, further cord-type gas generators can be coupled to the igniter housing 12. With this it is possible to provide third and further regions of a vehicle with vehicle occupant restraint devices that are activated by one igniter only. In this case, the relief opening 20a can function as an opening for connecting the further cord-type gas generator.

1. An inflation device (10) adapted for use in a vehicle occupant restraint system, comprising a housing (12), an igniter (14) received in the housing, and a first cord-type gas generator (22) connected to the housing (12), the cord-type gas generator (22) including a cord-shaped propellant strand (24), characterized in that the igniter housing (12) has at least one relief opening (20a, 20b) which is associated to a surrounding region outside the cord-type gas generator (22) and the housing (12).

2. The inflation device according to claim 1, characterized in that the housing encircles an igniter chamber (13) and that the igniter chamber (13) is in flow connection with the surrounding region (21) outside the housing (12) through at least one of the relief openings (20a, 20b) after activation of the igniter (16).

3. The inflation device according to claim 1, characterized in that the inflation device (10) has a pyrotechnical gas generator (30) including propellant elements (34), which gas generator is in flow connection through at least one of the relief openings (20a, 20b) with the igniter (14) after the ignition thereof, for igniting the propellant elements (34).

4. The inflation device according to claim 3, characterized in that the propellant elements (34) in the pyrotechnical gas generator (30) have a longer combustion time than the cord-shaped propellant strand (24).

5. The inflation device according to claim 3 or 4, characterized in that the propellant elements (34) are propellant tablets arranged in loose fill.

6. The inflation device according to any of the preceding claims, characterized in that the inflation device (10) has at least one further cord-type gas generator (22) connected to the housing (12).
